(19) United States
(12) Patent Application Publication
(10) Pub. No.: US 2017/0363942 A1
(43) Pub. Date: Dec. 21, 2017

(54) IMAGE PROJECTION APPARATUS, AND CONTROL METHOD OF IMAGE PROJECTION APPARATUS

(71) Applicants: Takahiro HIRAMATSU, Kanagawa (JP); Yasunari MIKUTSU, Tokyo (JP); Satoshi TSUCHIYA, Kanagawa (JP); Yukimi NISHI, Tokyo (JP)

(72) Inventors: Takahiro HIRAMATSU, Kanagawa (JP); Yasunari MIKUTSU, Tokyo (JP); Satoshi TSUCHIYA, Kanagawa (JP); Yukimi NISHI, Tokyo (JP)

(21) Appl. No.: 15/626,375

(22) Filed: Jun. 19, 2017

(30) Foreign Application Priority Data
Jun. 20, 2016 (JP) 2016-121812

(51) Int. Cl. G03B 21/20; H04N 9/31

(52) U.S. Cl. CPC G03B 21/2033; H04N 9/315; G03B 21/2053; G03B 21/206; G03B 21/2066

(57) ABSTRACT

An image projection apparatus includes a light source to emit light, an image generation unit including an image generation element to generate an image using the light emitted from the light source, an optical unit to guide the light emitted from the light source to the image generation unit, and to enlarge and project the image generated by the image generation unit, a drive unit to change any one of a position of the image generation element and a position of at least a part of the optical unit at specific timing, and a cooling device to cool one or more parts disposed in the image projection apparatus. An operation sound generated by the cooling device while the cooling device is being operated has a given frequency characteristic settable according to a drive frequency of the drive unit.

### CROSS-REFERENCE TO RELATED APPLICATION

This application claims priority pursuant to 35 U.S.C. §119(a) to Japanese Patent Application No. 2016-121812 filed on Jun. 20, 2016 in the Japan Patent Office, the disclosure of which is incorporated by reference herein in its entirety.

### BACKGROUND

### Technical Field

This disclosure relates to an image projection apparatus, and a control method of the image projection apparatus.

### Background Art

Image projection apparatuses that project images on a projection face (e.g., screen) are used in a wide range of fields such as presentations to a large number of persons such as conferences, lecture meetings, educational sites, and home theaters. When the image projection apparatus receives image data transmitted from an information processing apparatus such as a personal computer, a video reproduction device such as a digital versatile disk (DVD) player, an imaging device such as a digital camera, an optical image generation element (or modulation element, image generation element) generates an image based on the received image data, and then the image is projected on a projection face (e.g., screen) through an optical system including a plurality of lenses or the like.

The image projection apparatus includes a cooling device such as a cooling fan for cooling heat generated from a light source (lamp), a ballast (stabilizer), and a power supply device disposed in the image projection apparatus. When the cooling fan is operated, an operation sound is generated by rotation of the cooling fan, and a user feels the operation sound as noise sound. This noise sound may not become a problem when the image projection apparatus is used in a large space such as a hall. However, users may feel the operation sound as noise sound when the image projection apparatus is used in a smaller space such as a home theater.

JP-H09-164744-A discloses a method of reducing noise sound, in which a noise masking device generates a noise masking sound against the noise sound generated by a drive motor (i.e. noise source) to cancel the noise sound of the drive motor on the auditory sense.

In a case of increasing the resolution of images projected by the image projection apparatus, the pixel density of the optical image generation element (modulation element) may be increased by using a greater number of pixels of the optical image generation element. However, the manufacturing cost of the optical image generation element increases.

JP-2007-248721-A discloses an image display device that can display a higher resolution image, in which the image display device generates an intermediate image by shifting pixels by moving an optical element without increasing the number of pixels of an optical image generation element.

However, when the optical element is moved to shift the pixels in the image projection apparatus (referred to as pixel-shift control), an operation sound is generated when the optical element is moved for the pixel-shift control. Therefore, the operation sound generated by the cooling fan and the operation sound generated by the pixel-shift control occur concurrently, and thereby the number of the noise sources increases. Further, if a noise cancelling device such as a speaker for masking the noise sound is disposed in the image projection apparatus as disclosed in JP-H09-164744-A, the image projection apparatus becomes expensive and increases the size of the image projection apparatus, which are not preferable.

### SUMMARY

As one aspect of the present invention, an image projection apparatus is devised. The image projection apparatus includes a light source to emit light, an image generation unit including an image generation element to generate an image using the light emitted from the light source, an optical unit to guide the light emitted from the light source to the image generation unit, and to enlarge and project the image generated by the image generation unit, a drive unit to change any one of a position of the image generation element and a position of at least a part of the optical unit at specific timing, and a cooling device to cool one or more parts disposed in the image projection apparatus. An operation sound generated by the cooling device while the cooling device is being operated has a given frequency characteristic settable according to a drive frequency of the drive unit.

As another aspect of the present invention, a method of controlling an image projection apparatus including a light source to emit light, an image generation unit including an image generation element to generate an image using the light emitted from the light source, an optical unit to guide the light emitted from the light source to the image generation unit, and to enlarge and project the image generated by the image generation unit, a drive unit to change any one of a position of the image generation element and a position of a part of the optical unit at specific timing, and a cooling device to cool one or more parts disposed in the image projection apparatus is devised. The method includes operating the cooling device to cool the one or more parts disposed in the image projection apparatus; and controlling an operation of the cooling device to set frequency characteristic of an operation sound generated by the cooling device according to a drive frequency of the drive unit.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 is a perspective view of an image projection apparatus of an embodiment of the present invention;

FIG. 2 is a side view of the image projection apparatus of FIG. 1, and the image projection apparatus projects an image on a screen used as a projection face;

FIG. 3A is a perspective view of an internal configuration of the image projection apparatus of FIG. 1 from which an outer casing is removed;

FIG. 3B is a perspective view of an encircled portion in FIG. 3A;

FIG. 4 is a cross-sectional view of a light guide unit, an optical projection unit, an image generation unit, and a light source unit of the image projection apparatus of FIG. 1;

FIG. 5A is a functional block diagram illustrating an example of the image projection apparatus according to the embodiment;

FIG. 5B is an example of a hardware block diagram of a system controller of the image projection apparatus of FIG. 1;

FIG. 6 is a perspective view of an image generation unit according to the embodiment;

FIG. 7 is a side view of the image generation unit of FIG. 6;

FIG. 8 is a perspective view of a fixed unit according to the embodiment;

FIG. 9 is an exploded perspective view of the fixed unit of FIG. 8;

FIG. 10 illustrates a support structure of a movable plate using the fixed unit of FIG. 8;

FIG. 11 is a partially enlarged view of the support structure at a portion A in FIG. 10;

FIG. 12 is a bottom view of a top plate according to the embodiment;

FIG. 13 is a perspective view of a movable unit according to the embodiment;

FIG. 14 is an exploded perspective view of the movable unit of FIG. 13;

FIG. 15 is a perspective view of a movable plate according to the embodiment;

FIG. 16 is a perspective view of the movable unit of FIG. 13 from which the movable plate is removed;

FIG. 17 illustrates a DMD holding structure of the movable unit of FIG. 13, according to the embodiment;

FIGS. 18A, 18B, and 18C illustrate an example of a display state of an image when pixels are shifted;

FIGS. 19A and 19B illustrate another example of a display state of an image when pixels are shifted; and

FIG. 20 is an example of frequency characteristic of a noise sound of a cooling fan.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of present disclosure. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of present disclosure.

In addition, it should be noted that the terminology used herein is for the purpose of describing particular embodiments only and is not intended to be limiting of present disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. Furthermore, although in describing views illustrated in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more embodiments are described hereinafter.

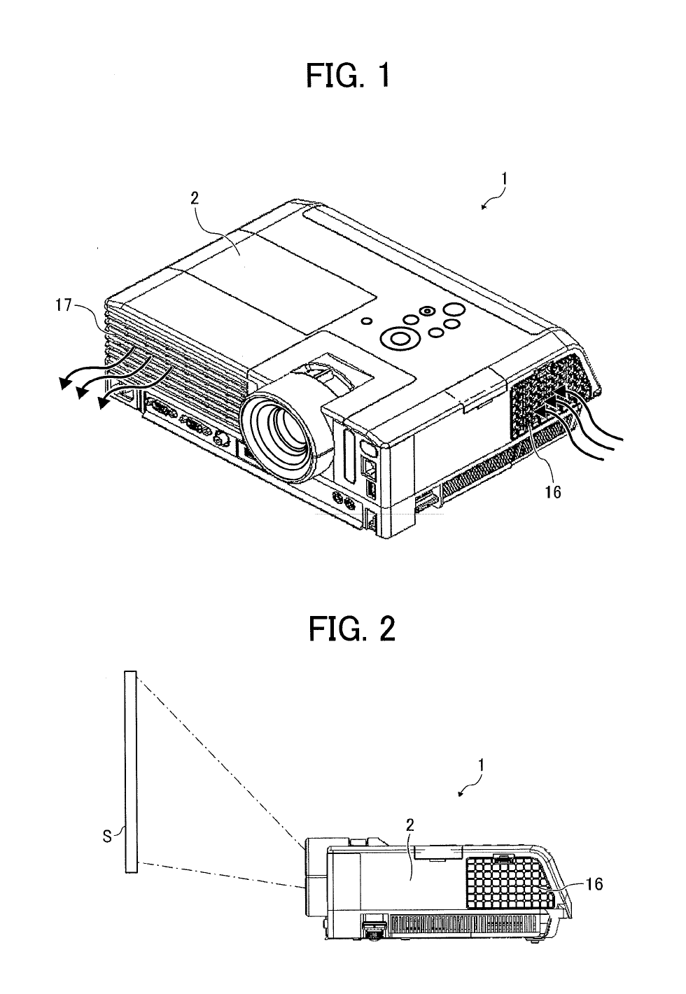

Hereinafter, a description is given of one or more embodiments of the present disclosure with reference to drawings of FIGS. 1 to 20.

### (Image Projection Apparatus)

FIG. 1 is a perspective view of an image projection apparatus 1 of an embodiment of the present invention. FIG. 2 is a side view of the image projection apparatus 1, and the image projection apparatus 1 projects an image on a screen S used as a projection face.

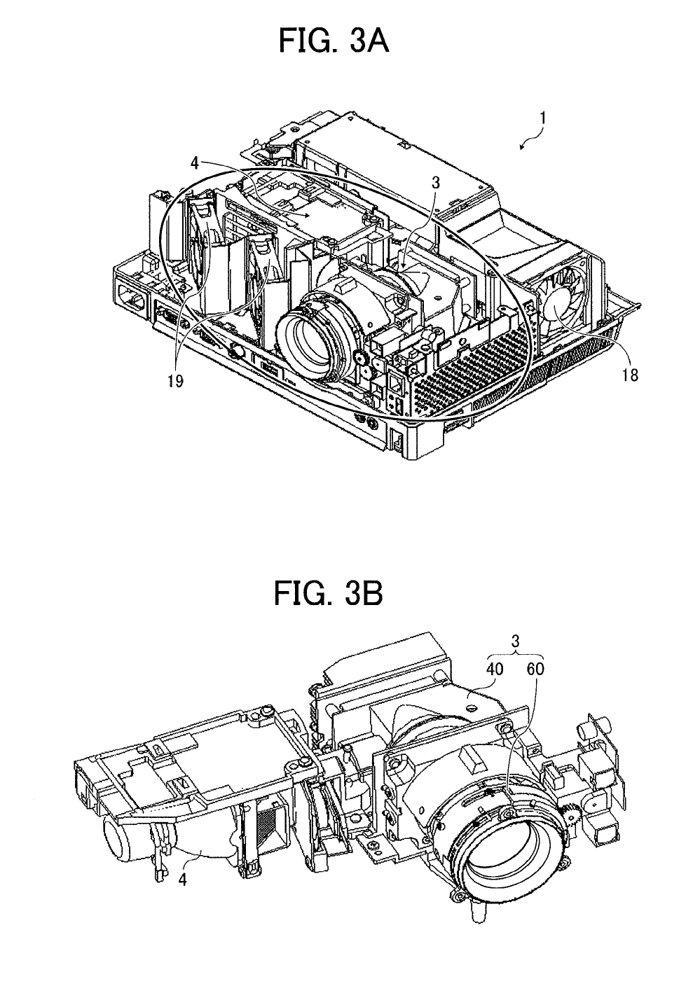

FIG. 3A is a perspective view of an internal configuration of the image projection apparatus 1 from which an outer casing 2 is removed. FIG. 3B is a perspective view of an encircled portion in FIG. 3A, in which an optical engine 3 and a light source unit 4 are included.

As to the image projection apparatus 1, there is a demand for making a projection screen larger while making a projection space necessary for the outside of the image projection apparatus 1 as small as possible. Lately, the performance of the optical engine 3 has been improved, with which the image projection apparatus 1 that can achieve a projection image size of 60 inch to 80 inch with a projection distance of 1 m to 2 m has become a mainstream configuration for the image projection apparatus.

In case of conventional image projection apparatuses that require a longer projection distance, a conference desk is set between an image projection apparatus and a screen, and the image projection apparatus is placed at a rear side of the conference desk. Lately, with the shortening of the projection distance of the image projection apparatus, the image projection apparatus can be placed at a front side of the conference desk, with which it becomes possible to freely utilize a space behind the image projection apparatus.

The image projection apparatus 1 has a lamp as a light source, and many electronic circuit boards inside the image projection apparatus 1. Therefore, the internal temperature of the image projection apparatus 1 rises after the image projection apparatus 1 is activated and being operated along the time line. Lately, the rise of internal temperature becomes prominent as the size of the casing of the image projection apparatus 1 has been reduced. Therefore, as illustrated in FIG. 1, the image projection apparatus 1 includes, for example, an intake port 16 and an exhaust port 17 to introduce air inside the image projection apparatus 1, and then to exhaust heated air outside the image projection apparatus 1 so that the temperature of the internal components does not exceed heatproof temperature of the internal components.

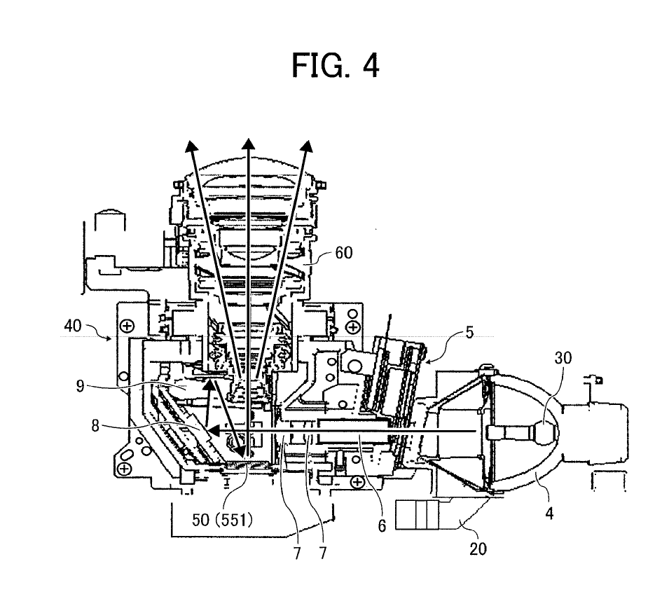

Further, as illustrated in FIG. 3A and FIG. 3B, the image projection apparatus 1 includes, for example, the optical engine 3 and the light source unit 4. FIG. 4 is a cross-sectional view of a light guide unit 40 to guide light emitted from the light source unit 4, an optical projection unit 60, an image generation unit 50, and the light source unit 4 when viewed from a top side of the image projection apparatus 1. The optical engine 3 includes, for example, the light guide unit 40 and the optical projection unit 60 as illustrated in FIG. 3A and FIG. 3B.

As illustrated in FIG. 3A, an intake fan 18 is disposed inside the image projection apparatus 1 near the intake port 16, and an exhaust fan 19 is disposed inside the image projection apparatus 1 near the exhaust port 17. When air is introduced from the intake fan 18 inside the image projection apparatus 1, and then heated air is exhausted from the exhaust fan 19, the internal space and components of the image projection apparatus 1 can be cooled by a forced air flow.

In the image projection apparatus 1, light (e.g., white light) coming from a light source in the light source unit 4 enters the light guide unit 40 of the optical engine 3. Inside the light guide unit 40, the white light is separated into RGB light components, and then guided to the image generation unit 50 via a lens and a mirror. Then, an image is generated by the image generation unit 50 based on modulation signals, and the image is magnified and projected to the screen S by the optical projection unit 60.

As illustrated in FIG. 4, the light source unit 4 includes, for example, a light source 30. The light source 30 employs various lamps such as arc lamps including a high pressure mercury lamp, a xenon lamp or the like. For example, a high pressure mercury lamp is used as the light source 30.

As illustrated in FIG. 4, a cooling fan 20 is disposed at one side of the light source unit 4 to cool the light source 30. The rotation speed of the cooling fan 20 is controlled so that temperature of each part of the light source unit 4 is within the rated temperature range set for each part of the light source unit 4. Further, the emission direction of the light from the light source unit 4 and the emission direction of the image light from the optical projection unit 60 are set with a relationship of approximately 90 degrees as illustrated in FIG. 4. In this description, the cooling fan 20 is used as an example of the cooling device. As long as the cooling device can cool the light source unit 4, any cooling devices can be used.

Further, in the optical engine 3, the light guide unit 40 includes, for example, a color wheel 5, a light tunnel 6, two relay lenses 7, a flat mirror 8, and a concave mirror 9. The color wheel 5 (e.g., disk-shaped rotatable color filter) separates light emitted from the light source 30. The light tunnel 6 guides the light exiting from the color wheel 5. Further, the light guide unit 40 includes, for example, the image generation unit 50.

In the light guide unit 40, as indicated by arrows of FIG. 4, the white light, which is the light emitted from the light source 30, is separated into R (red), G (green), and B (blue) light components time divisionally when the light emitted from the light source 30 passes through the color wheel 5 rotating in one direction. The R (red), G (green), and B (blue) light components exiting from the color wheel 5 enter the light tunnel 6. The light tunnel 6 is a tube-shaped member having a square-like cross shape, and its internal face is finished as a mirror face. Each of the light components that enters the light tunnel 6 reflects for a plurality of times on the internal face of the light tunnel 6, and is then emitted as synthesized uniform light to the two relay lenses 7. Therefore, the light tunnel 6 is used as an optical member to convert the light into uniformed light.

Then, the light exiting from the light tunnel 6 enters the two relay lenses 7, in which the light is condensed while correcting the chromatic aberration along the light axis by the two relay lenses 7, which is a combination of two lenses. The light exiting from the two relay lenses 7 is reflected by the flat mirror 8 and the concave mirror 9, and then enters the image generation unit 50. The image generation unit 50 includes, for example, a digital micromirror device (DMD) 551 used as an image generation element or modulation element. The DMD 551 includes, for example, a plurality of micromirrors, and the plurality of micromirrors configure a substantially rectangular mirror surface. When each of micromirrors is driven by a time division control based on image data, the light is processed and reflected by the DMD 551 to generate an image light.

The image generation unit 50 selects the light that is output to the optical projection unit 60 by switching on and off of the micromirrors based on the input signals, and generates the gradation by controlling the micromirrors. Specifically, the light used for a projection image is reflected to a projection lens by the plurality of micromirrors, and the light to be discarded is reflected to an OFF plate by the DMD 551 based on image data in a time division manner. The image light generated by the image generation unit 50 is reflected to the optical projection unit 60, passes through the plurality of projection lenses disposed in the optical projection unit 60, and then projected onto the screen S as an enlarged image.

Further, the incident side of the two relay lenses 7, the flat mirror 8, the concave mirror 9, the image generation unit 50, and the optical projection unit 60 inside the light guide unit 40 is covered by a housing, and the mating surface of the housings is sealed with a sealant to configure a dust-proof structure.

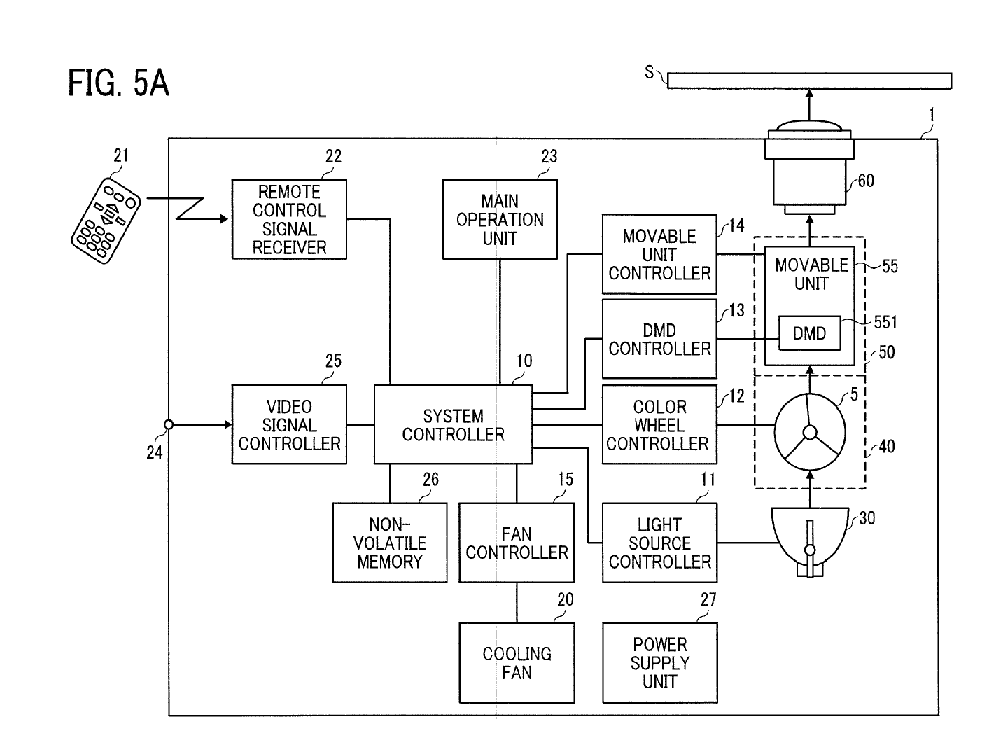

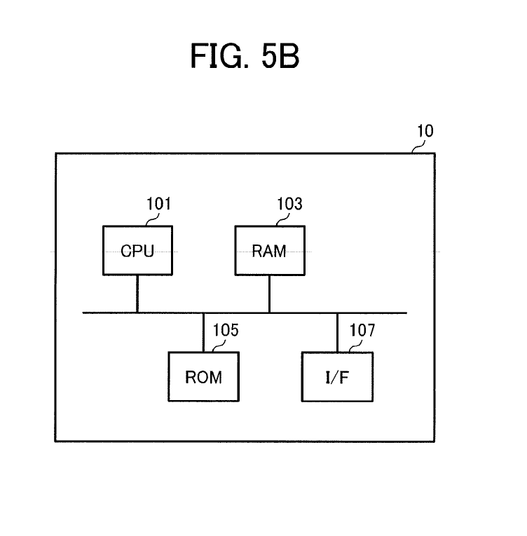

FIG. 5A is a functional block diagram illustrating an example of the image projection apparatus 1 according to the embodiment.

As illustrated in FIG. 5A, the image projection apparatus 1 includes, for example, a system controller 10, a light source controller 11, a color wheel controller 12, a DMD controller 13, a movable unit controller 14, a fan controller 15, the cooling fan 20, a remote control signal receiver 22, a main operation unit 23, an input terminal 24, a video signal controller 25, a non-volatile memory 26, a power supply unit 27, the light source 30, the light guide unit 40, the image generation unit 50, and the optical projection unit 60 to project an image onto the screen S. The image projection apparatus 1 further includes, for example, a remote controller 21 as a remote control means.

The system controller 10 performs overall control of the image projection apparatus 1. Further, the system controller 10 controls various image processing such as contrast adjustment, brightness adjustment, sharpness adjustment, scaling processing, conversion of frame rate of frames per second (fps) (refresh rate (Hz)), frame generation in an pixel shift control operation, display processing such as on-screen display (OSD) of menu information, and various other processing.

Further, the system controller 10 is connected with the light source controller 11, the color wheel controller 12, the DMD controller 13, the movable unit controller 14, the fan controller 15, the remote control signal receiver 22, the main operation unit 23, the video signal controller 25, and the non-volatile memory 26, and controls each of these functional units.

FIG. 5B is an example of a hardware block diagram of the system controller 10 of the image projection apparatus 1, according to the embodiment. As illustrated in FIG. 5B, the system controller 10 includes, for example, a central processing unit (CPU) 101, a read-only memory (ROM) 105, a random access memory (RAM) 103, and an interface (I/f) 107, and the functions of the units of the system controller 10 are implemented when the CPU 101 executes programs stored in the ROM 105 in cooperation with the RAM 103, but not limited thereto. For example, at least part of the functions of the units of the system controller 10 can be implemented by a dedicated hardware circuit such as a semiconductor integrated circuit. The program executed by the system controller 10 according to the embodiment may be configured to be provided by being recorded in a computer-readable recording medium such as a compact disk read only memory (CD-ROM), a flexible disk (FD), a compact disk recordable (CD-R), a digital versatile disk (DVD), and a universal serial bus (USB) memory as a file of an installable format or an executable format. Alternatively, the program may be configured to be provided or distributed through a network such as the Internet. Moreover, various programs may be configured to be provided by being pre-installed into a non-volatile recording medium such as ROM 105. Further, the hardware block configuration of FIG. 5B can be applied to other controllers.

The input terminal 24 is an interface for inputting a video signal, and includes, for example, Video Graphics Array (VGA) input terminal such as a D-Sub connector, and a video terminal such as High-Definition Multimedia Interface (HDMI) (registered trademark) terminal, S-VIDEO terminal, and RCA terminal. The image projection apparatus 1 receives a video signal from a video supply apparatus such as a computer or an audio visual (AV) device via a cable connected to the input terminal 24. Further, in some cases, the image projection apparatus 1 includes a plurality of input terminals 24.

The video signal controller 25 processes a video signal input to the input terminal 24, and performs various processes such as serial-parallel conversion and voltage level conversion on the video signal. Further, the video signal controller 25 has a signal determination function for analyzing the resolution and frequency of video signals.

The non-volatile memory 26 stores data to be used for the image processing of video signal and various other processing. For example, the non-volatile memory 26 can be a non-volatile semiconductor memory such as an erasable programmable read-only memory (EPROM), an electrically erasable programmable read-only memory (EEPROM), and a flash memory. The image projection apparatus 1 can save or store previously set contents (e.g., language setting) in the non-volatile memory 26 even after the power is turned off.

The main operation unit 23 is an interface for operating the image projection apparatus 1, and receives various operation requests from a user. Upon receiving an operation request, the main operation unit 23 reports the operation request to the system controller 10. The main operation unit 23 is configured, for example, by operation keys (e.g., operation buttons) provided on an outer surface of the image projection apparatus 1.

The remote control signal receiver 22 receives an operation signal from the remote controller 21. Upon receiving the operation signal from the remote controller 21, the remote control signal receiver 22 reports the operation signal to the system controller 10.

A user can set various settings by operating the main operation unit 23 or the remote controller 21. For example, the user can instruct to display a menu screen, select an installation state of the image projection apparatus 1, a change request of the aspect ratio of the image projection apparatus 1, a power supply ON/OFF request of the image projection apparatus 1, a lamp power change request to change light intensity of the light source 30, an image mode change to change image quality (e.g., high brightness, standard, natural) of a projected image, a freeze request to stop the projected image, an operation mode change request for a pixel-shift control operation, an ON/OFF setting of the pixel-shift control operation, and the like.

The fan controller 15 controls the cooling fan 20 so that the temperature in the image projection apparatus 1 and the temperature of the light source 30 are within a specific temperature range such as heatproof temperature range.

The power supply unit 27 is connected to each device in the image projection apparatus 1, and converts an alternating current (AC) power, input from an electrical outlet, into a direct current (DC), and supplies the DC to each device in the image projection apparatus 1.

The light source 30 is, for example, a high pressure mercury lamp, which emits light by a discharge between a pair of electrodes, and the light source 30 irradiates light to the light guide unit 40. Further, the light source 30 can use a xenon lamp, and a light emitting diode (LED). Further, the light source controller 11 controls ON/OFF of the light source 30 and the light power.

The light emitted from the light source 30 is separated into R (red), G (green), and B (blue) light components time divisionally when the light emitted from the light source 30 passes through the color wheel 5 rotating in one direction in the light guide unit 40, in which each color light exits from the disc-shaped color wheel 5 at each unit time.

The color wheel controller 12 controls the rotation movement of the color wheel 5.

The light exiting from the color wheel 5 is condensed on the DMD 551 used as the image generation element in the image generation unit 50 via the light tunnel 6, the two relay lenses 7, the flat mirror 8, and the concave mirror 9.

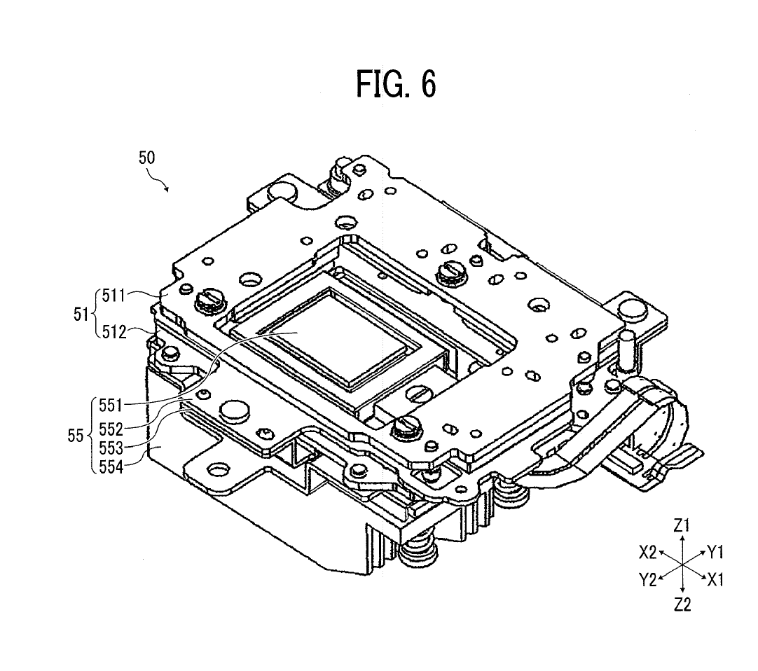

The image generation unit 50 includes, for example, a fixed unit 51 (FIG. 6) fixed to a frame, and a movable unit 55 movably supported by the fixed unit 51 so that the movable unit 55 can be moved with respect to the fixed unit 51. The movable unit 55 includes, for example, the DMD 551. The position of the movable unit 55 with respect to the fixed unit 51 is controlled by the movable unit controller 14.

The movable unit 55 includes, for example, an electromagnetic actuator (e.g., voice coil, magnet) as a drive unit. The movable unit controller 14 controls the amount of current to flow to the drive unit of the movable unit 55 to control the shift amount of the DMD 551. The shift control of the DMD 551 by the movable unit controller 14 can be turned on/off by operating the main operation unit 23 or the remote controller 21. When the shift control of the DMD 551 is set to OFF, a normal projection image not performing the shifting of DMD 551 is displayed.

The DMD 551 has a substantially rectangular mirror surface configured by the plurality of micromirrors. When each of micromirrors is driven by a time division control based on image data, the light coming from the light guide unit 40 is processed and reflected by the DMD 551 to generate an image light. The DMD controller 13 controls on/off of the micromirrors of the DMD 551.

The light used for a projection image is reflected to the optical projection unit 60 by the plurality of micromirrors of the DMD 551, and the light to be discarded is reflected to the OFF plate by the DMD 551 based on image data in a time division manner. The image light generated by the image generation unit 50 is reflected to the optical projection unit 60, passes through the optical projection unit 60, and then projected onto the screen S as an enlarged image.

The optical projection unit 60 includes, for example, a plurality of projection lenses and mirrors. The optical projection unit 60 magnifies or enlarges the image generated by the DMD 551 of the image generation unit 50, and project the magnified or enlarged image on the screen S.

### (Image Generation Unit)

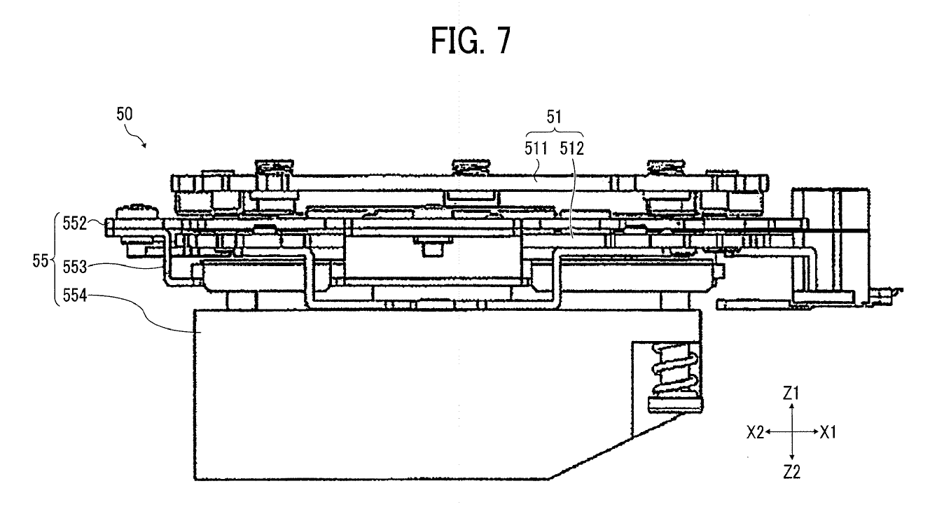

FIG. 6 is a perspective view of the image generation unit 50 according to the embodiment. FIG. 7 is a side view of the image generation unit 50 according to the embodiment.

As illustrated in FIG. 6 and FIG. 7, the image generation unit 50 includes the fixed unit 51, and the movable unit 55. The fixed unit 51 is fixed to a frame of the image projection apparatus 1 while the movable unit 55 is moveably supported by the fixed unit 51. The fixed unit 51 may be also referred to as a non-movable unit.

The fixed unit 51 includes a top plate 511 as a first fixed plate, and a base plate 512 as a second fixed plate. In the fixed unit 51, the top plate 511 and the base plate 512 are provided in parallel to each other with a given space therebetween.

The movable unit 55 includes the DMD 551, a movable plate 552 as a first movable plate, a coupling plate 553 as a second movable plate, and a heat sink 554, and the movable unit 55 is movably supported by the fixed unit 51.

The movable plate 552 is provided between the top plate 511 and the base plate 512 of the fixed unit 51, and is supported by the fixed unit 51 in parallel to the top plate 511 and the base plate 512 and is movably supported by the fixed unit 51 in a direction parallel to the surfaces of the top plate 511 and the base plate 512.

The coupling plate 553 is fixed to the movable plate 552 by interposing the base plate 512 of the fixed unit 51 between the coupling plate 553 and the movable plate 552. As to the coupling plate 553, the DMD 551 is fixed to the upper side of the coupling plate 553, and the heat sink 554 is fixed to the lower side of the coupling plate 553. The coupling plate 553 is fixed to the movable plate 552, and is thereby movably supported by the fixed unit 51 together with the movable plate 552, the DMD 551, and the heat sink 554.

The DMD 551 is provided on a plane of the coupling plate 553 closer to the movable plate 552, and is provided movably together with the movable plate 552 and the coupling plate 553. The DMD 551 includes an image generation plane where a plurality of movable micromirrors are arranged in a lattice pattern. As to each of the micromirrors of the DMD 551, the mirror surface of each of the micromirrors of the DMD 551 is mounted tiltably about a torsion axis, and each of the micromirrors of the DMD 551 is ON/OFF driven based on an image signal transmitted from the DMD controller 13.

For example, in the case of “ON”, an inclination angle of the micromirror is controlled so as to reflect the light emitted from the light source 30 to the optical projection unit 60. Further, for example, in the case of “OFF”, an inclination angle of the micromirror is controlled in a direction for reflecting the light emitted from the light source 30 toward the OFF plate.

With this configuration, the inclination angle of each of the micromirrors of the DMD 551 is controlled based on the image signal transmitted from the DMD controller 13, and the DMD 551 modulates the light emitted from the light source 30 and passing through the light guide unit 40 to generate a projection image.

The heat sink 554 is an example of a heat radiating unit, and is provided such that at least part of the heat sink 554 is in contact with the DMD 551. The heat sink 554 is provided for the movably supported coupling plate 553 together with the DMD 551 such that the heat sink 554 is in contact with the DMD 551, with which the DMD 551 can be efficiently cooled. Based on this configuration, in the image projection apparatus 1 according to the embodiment, the heat sink 554 suppresses an increase of the temperature of the DMD 551 so that occurrence of troubles such as a malfunction or a failure due to the increase of the temperature of the DMD 551 can be reduced.

### (Fixed Unit)

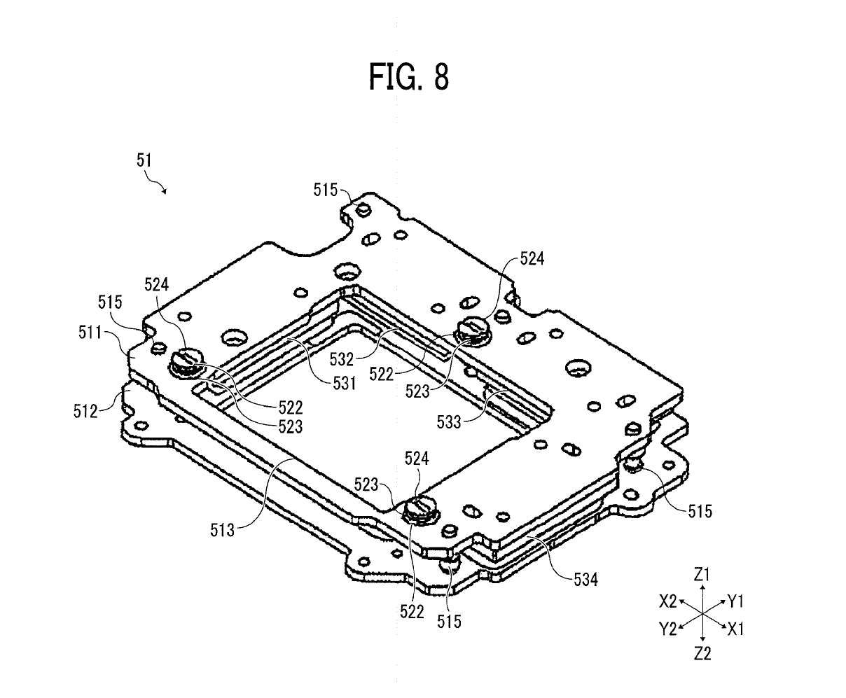

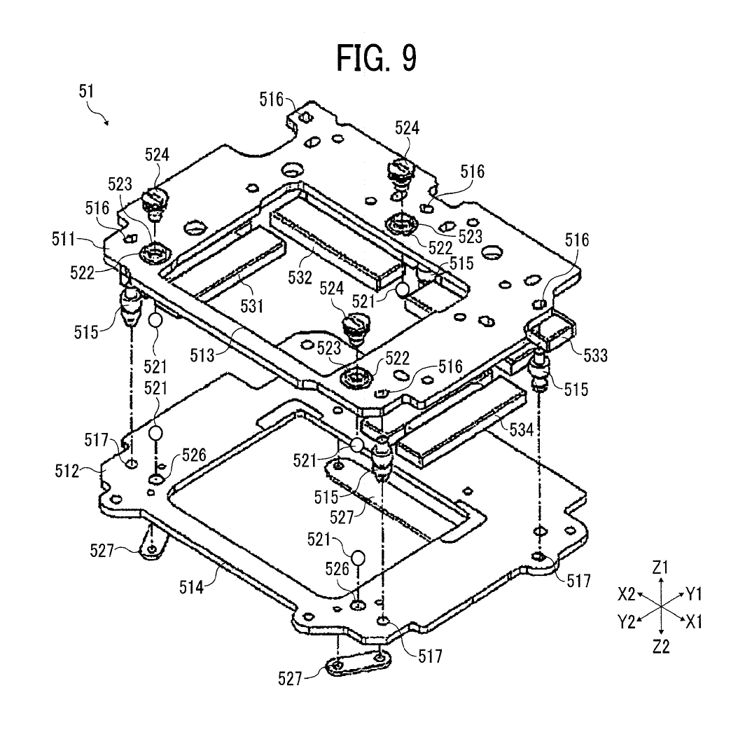

FIG. 8 is a perspective view of the fixed unit 51 according to the embodiment. FIG. 9 is an exploded perspective view of the fixed unit 51 according to the embodiment.

As illustrated in FIG. 8 and FIG. 9, the fixed unit 51 includes the top plate 511 and the base plate 512.

The top plate 511 and the base plate 512 are each formed from a plate member, and have central holes 513 and 514 respectively provided at positions corresponding to the DMD 551 of the movable unit 55. The top plate 511 and the base plate 512 are provided in parallel to each other by a plurality of supports 515 with a given space therebetween.

As illustrated in FIG. 9, an upper end of the support 515 is pressed into a supporting hole 516 formed in the top plate 511, and a lower end of the support 515 where a male screw groove is formed is inserted into a supporting hole 517 formed in the base plate 512. A plurality of the supports 515 forms a given space between the top plate 511 and the base plate 512 and supports the top plate 511 and the base plate 512 in a parallel manner.

Further, a plurality of supporting holes 522 and 526, each of which rotatably holds a supporting sphere 521, are formed in the top plate 511 and the base plate 512, respectively.

A cylindrical holding member 523 having a female screw groove in its inner periphery is inserted into the supporting hole 522 of the top plate 511. The holding member 523 rotatably holds the supporting sphere 521, and a position adjustment screw 524 is inserted into the holding member 523 from above. The supporting hole 526 of the base plate 512 is covered at its lower end by a lid member 527, and rotatably holds the supporting sphere 521.

The supporting spheres 521 rotatably held by the respective supporting holes 522 and 526 of the top plate 511 and the base plate 512 are in contact with the movable plate 552 provided between the top plate 511 and the base plate 512 to movably support the movable plate 552.

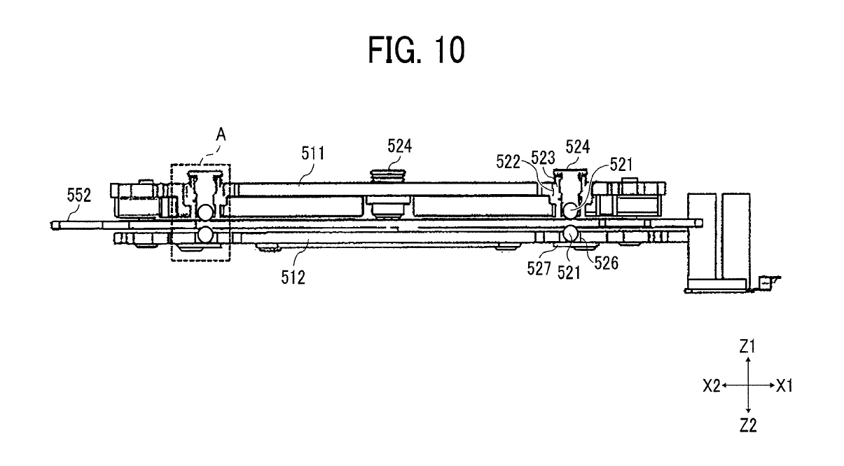

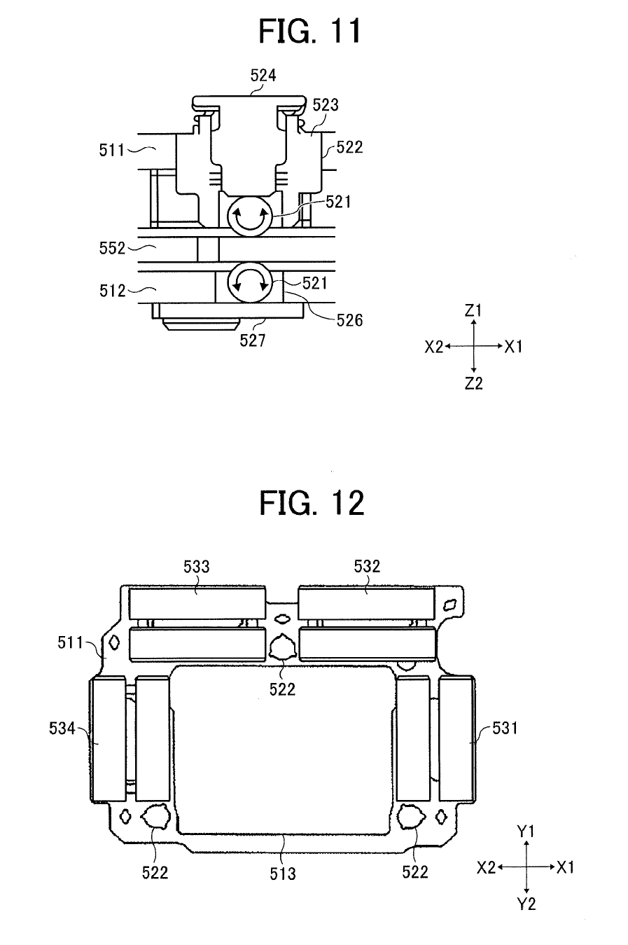

FIG. 10 illustrates a support structure of the movable plate 552 using the fixed unit 51. FIG. 11 is a partially enlarged view of the support structure at a portion A in FIG. 10.

As illustrated in FIG. 10 and FIG. 11, in the top plate 511, the supporting sphere 521 is rotatably held by the holding member 523 inserted into the supporting hole 522. In the base plate 512, the supporting sphere 521 is rotatably held by the supporting hole 526 whose lower end is covered by the lid member 527.

The supporting spheres 521 are held such that at least part thereof protrudes from the supporting holes 522 and 526, and are in contact with and supporting the movable plate 552 provided between the top plate 511 and the base plate 512. The movable plate 552 is supported by the rotatably provided supporting spheres 521 from both sides of the movable plate 552 so as to be supported in parallel to the top plate 511 and the base plate 512 and movably in a direction parallel to the surfaces of the top plate 511 and the base plate 512.

Further, as to the supporting sphere 521 provided on the top plate 511, an amount of protrusion of the supporting sphere 521 from the lower end of the holding member 523 is changed by adjusting the position of the position adjustment screw 524 that contacts with the supporting sphere 521 at one side of the supporting sphere 521 that is farther from the movable plate 552. For example, when the position adjustment screw 524 is displaced in the Z1 direction, the amount of protrusion of the supporting sphere 521 decreases, with which a space between the top plate 511 and the movable plate 552 is reduced. Further, for example, when the position adjustment screw 524 is displaced in the Z2 direction, the amount of protrusion of the supporting sphere 521 increases, with which a space between the top plate 511 and the movable plate 552 is increased.

With this configuration, by changing the amount of protrusion of the supporting sphere 521 using the position adjustment screw 524, the space between the top plate 511 and the movable plate 552 can be appropriately adjusted.

Further, as illustrated in FIG. 8 and FIG. 9, magnets 531, 532, 533, and 534 are provided on the plane of the top plate 511 closer to the base plate 512.

FIG. 12 is a bottom view of the top plate 511 according to the embodiment. As illustrated in FIG. 12, the magnets 531, 532, 533, and 534 are provided on the plane of the top plate 511 closer to the base plate 512.

The magnets 531, 532, 533, and 534 are arranged at four locations so as to surround the central hole 513 of the top plate 511. Each of the magnets 531, 532, 533, and 534 is configured with two cuboid magnets arranged such that their longitudinal directions are parallel to each other, and the two cuboid magnets form a magnetic field effecting the movable plate 552.

The magnets 531, 532, 533, and 534 configure a movement unit for moving the movable plate 552 in cooperation with coils that are provided on the upper surface of the movable plate 552 while each of the coils facing the magnets 531, 532, 533, and 534.

Further, the number, the locations, and the like of the supports 515 and the supporting spheres 521 provided in the fixed unit 51 are not limited to the configuration illustrated in the embodiment as long as they are capable of movably supporting the movable plate 552.

### (Movable Unit)

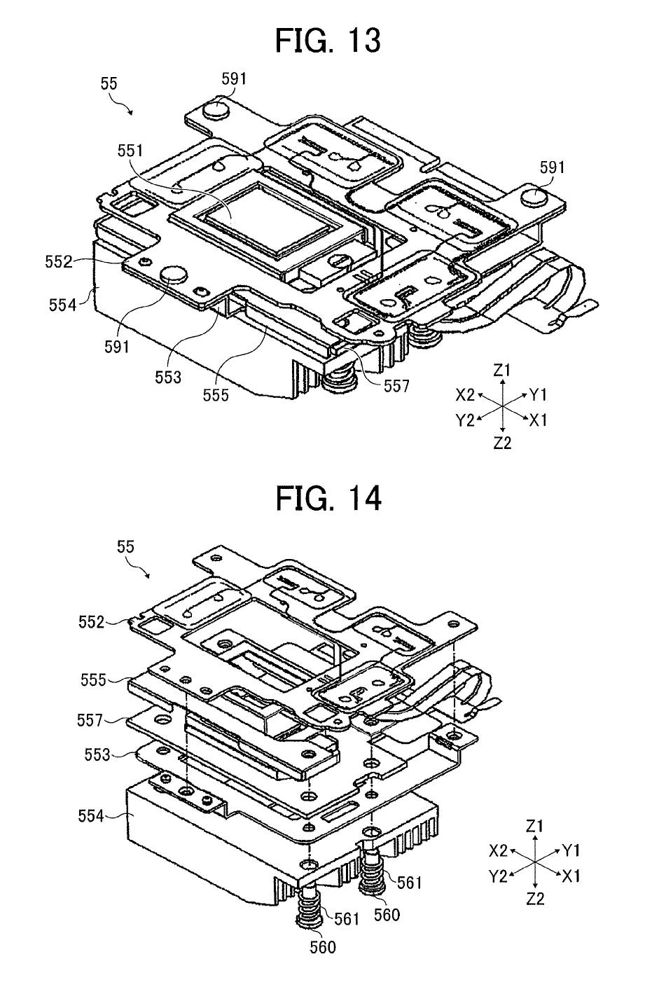

FIG. 13 is a perspective view of the movable unit 55 according to the embodiment. FIG. 14 is an exploded perspective view of the movable unit 55 according to the embodiment.

As illustrated in FIG. 13 and FIG. 14, the movable unit 55 includes the DMD 551, the movable plate 552, the coupling plate 553, the heat sink 554, a holding member 555, and a DMD substrate 557, and is movably supported by the fixed unit 51.

As described above, the movable plate 552 is provided between the top plate 511 and the base plate 512 of the fixed unit 51, and is supported movably in a direction parallel to the surfaces of the top plate 511 and the base plate 512 by the supporting spheres 521.

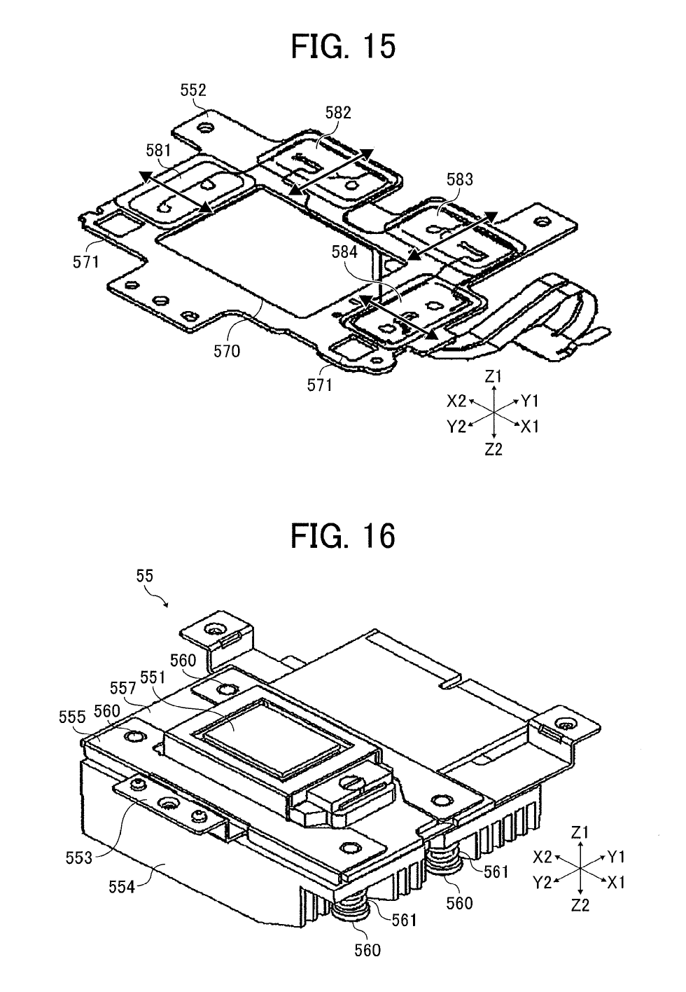

FIG. 15 is a perspective view of the movable plate 552 according to the embodiment.

As illustrated in FIG. 15, the movable plate 552 is formed from a plate member, has a central hole 570 made at a position corresponding to the DMD 551 provided in the DMD substrate 557, and also has coils 581, 582, 583, and 584 provided around the central hole 570.

Each of the coils 581, 582, 583, and 584 is formed by an electric wire being wound around an axis parallel to the Z1-Z2 direction, is provided in a recess formed on the side of the movable plate 552 closer to the top plate 511, and is covered with a cover. The coils 581, 582, 583, and 584 configure the movement unit for moving the movable plate 552 in cooperation with the respective magnets 531, 532, 533, and 534 of the top plate 511.

The magnets 531, 532, 533, and 534 of the top plate 511 and the coils 581, 582, 583, and 584 of the movable plate 552 are provided in locations so as to face each other, respectively, in the state that the movable unit 55 is supported by the fixed unit 51. When a current is made to flow in the coils 581, 582, 583, and 584, a Lorentz force used as a drive force for moving the movable plate 552 is generated by the magnetic field formed by the magnets 531, 532, 533, and 534.

When the movable plate 552 receives the Lorentz force as the drive force generated between the magnets 531, 532, 533, and 534 and the coils 581, 582, 583, and 584, the movable plate 552 is linearly or rotationally displaced on the X-Y plane with respect to the fixed unit 51.

The magnitude and direction of the current flowing in each of the coils 581, 582, 583, and 584 is controlled by the movable unit controller 14. The movable unit controller 14 controls a movement direction (linear or rotation direction), a movement amount, and a rotation angle of the movable plate 552 by controlling the magnitude and direction of the current flowing in each of the coils 581, 582, 583, and 584.

In the embodiment, the coil 581 and the magnet 531 facing each other and the coil 584 and the magnet 534 facing each other disposed at the opposite positions in the X1-X2 direction configure a first drive unit. When a current is made to flow in the coil 581 and the coil 584, the Lorentz force is generated in the X1 direction or in the X2 direction as illustrated in FIG. 15. The movable plate 552 is moved in the X1 direction or in the X2 direction by the Lorentz forces generated between the coil 581 and the magnet 531 and between the coil 584 and the magnet 534.

Further, in the embodiment, the coil 582 and the magnet 532 facing each other and the coil 583 and the magnet 533 facing each other disposed in parallel in the X1-X2 direction configure a second drive unit. Further, the magnet 532 and the magnet 533 are arranged such that the longitudinal directions of the magnet 532 and the magnet 533 are perpendicular to the longitudinal directions of the magnet 531 and the magnet 534. Based on this configuration, when a current is made to flow in the coil 582 and the coil 583, the Lorentz force is generated in the Y1 direction or in the Y2 direction as illustrated in FIG. 15.

The movable plate 552 is moved in the Y1 direction or in the Y2 direction by the Lorentz forces generated between the coil 582 and the magnet 532 and between the coil 583 and the magnet 533. Further, the movable plate 552 is displaced to rotate on the X-Y plane by a Lorentz force generated between the coil 582 and the magnet 532 and a Lorentz force generated between the coil 583 and the magnet 533, which are generated in the opposite directions.

For example, when a current is made to flow such that a Lorentz force is generated in the Y1 direction by the coil 582 and the magnet 532 and a Lorentz force is generated in the Y2 direction by the coil 583 and the magnet 533, the movable plate 552 is displaced to rotate clockwise when viewed from the top. Further, when a current is made to flow such that a Lorentz force is generated in the Y2 direction by the coil 582 and the magnet 532 and a Lorentz force is generated in the Y1 direction by the coil 583 and the magnet 533, the movable plate 552 is displaced to rotate counterclockwise when viewed from the top.

Further, a movable range restriction hole 571 is provided in the movable plate 552 at a position corresponding to the support 515 of the fixed unit 51. The support 515 of the fixed unit 51 is inserted in the movable range restriction hole 571, and the movable range restriction hole 571 restricts a movable range of the movable plate 552 by coming in contact with the support 515 when the movable plate 552 is largely moved due to, for example, vibration or some abnormality.

As described above, in the embodiment, the movable unit controller 14 controls the magnitude or the direction of the current to be made to flow in the coils 581, 582, 583, and 584, with which the movable plate 552 can be moved to any positions within the movable range.

Further, the number, the locations, and the like of the magnets 531, 532, 533, and 534 and the coils 581, 582, 583, and 584, which function as the movement unit, may be configured in a different manner from that of the embodiment as long as the movable plate 552 can be moved to any positions. For example, the magnets used as the movement unit may be provided on the upper surface of the top plate 511 or may be provided on any plane of the base plate 512. Further, for example, a configuration in which the magnets are provided on the movable plate 552 and the coils are provided on the top plate 511 or the base plate 512, may be employed.

Further, the number, the locations, the shape, and the like of the movable range restriction hole 571 are not limited to the configuration illustrated in the embodiment. For example, the number of movable range restriction holes 571 may be one or plural. Further, the shape of the movable range restriction hole 571 may be different from that of the embodiment, and may be a rectangle or a circle.

As illustrated in FIG. 13, the coupling plate 553 is fixed to the lower side (the side closer to the base plate 512) of the movable plate 552 movably supported by the fixed unit 51. The coupling plate 553 is formed from a plate member, has a central hole made at a position corresponding to the DMD 551, and has bent portions provided at periphery of the coupling plate 553 that are fixed to the lower side of the movable plate 552 by using three screws 591.

FIG. 16 is a perspective view of the movable unit 55 from which the movable plate 552 is removed.

As illustrated in FIG. 16, the coupling plate 553 has the DMD 551 provided on its upper surface and the heat sink 554 provided on its lower surface. Since the coupling plate 553 is fixed to the movable plate 552, the coupling plate 553 having the DMD 551 and the heat sink 554 is provided movably with respect to the fixed unit 51 as the movable plate 552 is provided movably with respect to the fixed unit 51.

The DMD 551 is provided on the DMD substrate 557, and the DMD substrate 557 is sandwiched between the holding member 555 and the coupling plate 553, with which the DMD 551 is fixed to the coupling plate 553. As illustrated in FIG. 14 and FIG. 16, the holding member 555, the DMD substrate 557, the coupling plate 553, and the heat sink 554 are overlapped and fixed using stepped screws 560 as fixing units and springs 561 as pressing units.

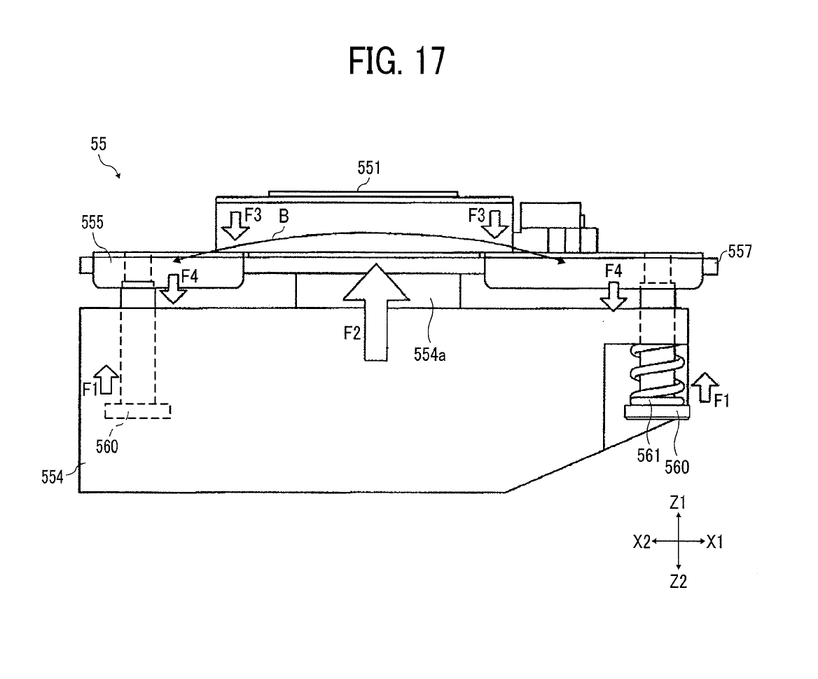

FIG. 17 illustrates a DMD holding structure of the movable unit 55 according to the embodiment. FIG. 17 is a side view of the movable unit 55, in which the movable plate 552 and the coupling plate 553 are omitted.

As illustrated in FIG. 17, the heat sink 554 has a projecting portion 554a in contact with the lower side of the DMD 551 through a through hole provided in the DMD substrate 557 in the state that the heat sink 554 is fixed to the coupling plate 553. Further, the projecting portion 554a of the heat sink 554 may be provided such that it is in contact with a position of the lower side of the DMD substrate 557 corresponding to the DMD 551.

Further, to enhance a cooling effect of the DMD 551, an elastically deformable heat transfer sheet may be provided between the projecting portion 554a of the heat sink 554 and the DMD 551. By providing the elastically deformable heat transfer sheet between the projecting portion 554a of the heat sink 554 and the DMD 551, a thermal conductivity between the projecting portion 554a of the heat sink 554 and the DMD 551 is enhanced, and the cooling effect of the DMD 551 by the heat sink 554 is enhanced.

As described above, the holding member 555, the DMD substrate 557, and the heat sink 554 are overlapped and fixed using the stepped screws 560 and the springs 561. When the stepped screws 560 are tightened, the springs 561 are compressed in the Z1-Z2 direction, and a force F1 in the Z1 direction illustrated in FIG. 17 is generated from the spring 561. The heat sink 554 is pressed against the DMD 551 by a force F2 in the Z1 direction due to forces F1 generated from the springs 561.

In the embodiment, the stepped screws 560 and the springs 561 are provided at four locations, and the force F2 applied to the heat sink 554 is equal to that obtained by combining the forces F1 generated in the four springs 561. Further, the force F2 from the heat sink 554 acts on the holding member 555 that holds the DMD substrate 557 where the DMD 551 is provided. Consequently, a force F3 in the Z2 direction corresponding to the force F2 from the heat sink 554 is generated in the holding member 555, so that the DMD substrate 557 can be held between the holding member 555 and the coupling plate 553.

A force F4 in the Z2 direction acts on the stepped screw 560 and the spring 561 from the force F3 generated in the holding member 555. Since the springs 561 are provided at the four locations, the force F4 acting on each of the springs 561 is equivalent to a quarter of the force F3 generated in the holding member 555, and is resultantly balanced with the force F1.

Further, the holding member 555 is a member capable of bending or warping as illustrated by arrow B in FIG. 17, and is formed as a plate spring. The holding member 555 is bent or warped by being pressed by the projecting portion 554a of the heat sink 554 and a force to push back the heat sink 554 in the Z2 direction is generated, with which it is possible to firmly keep the contact between the DMD 551 and the heat sink 554.

As described above, as to the movable unit 55, the movable plate 552 and the coupling plate 553 that includes the DMD 551 and the heat sink 554 are movably supported by the fixed unit 51. The position of the movable unit 55 is controlled by the movable unit controller 14. Further, the heat sink 554 in contact with the DMD 551 is provided in the movable unit 55, so that occurrence of troubles such as a malfunction and a failure caused by an increase of the temperature of the DMD 551 can be suppressed, in particular prevented.

### (Shifting of Pixel (Shifting of DMD))

As described above, in the image projection apparatus 1 according to the embodiment, the DMD 551 that generates a projection image is provided in the movable unit 55, and the position of the DMD 551 is controlled by the movable unit controller 14 together with the movable unit 55.

For example, the movable unit controller 14 controls the position of the movable unit 55 so as to move the movable unit 55 with a higher speed between a plurality of positions, which are apart from each other by a distance that is less than an arrangement interval of the micromirrors of the DMD 551 with a given cycle corresponding to a frame rate at the time of projecting images. When the movable unit 55 is moved (i.e., position of the DMD 551 is shifted), the DMD controller 13 transmits an image signal to the DMD 551 so as to generate a projection image based on the shifted position of the DMD 551.

For example, the movable unit controller 14 reciprocally moves the DMD 551 with the given cycle between a position PA and a position PB, which are apart from each other by a distance that is less than an arrangement interval of the micromirrors of the DMD 551 in the X1-X2 direction and in the Y1-Y2 direction. At this timing, the DMD controller 13 controls the DMD 551 so as to generate a shifted projection image based on the shifted position of the DMD 551 so that a resolution of the projection image can be made about twice the resolution of the DMD 551.

With this configuration, the movable unit controller 14 moves the DMD 551 together with the movable unit 55 with the given cycle, and the DMD controller 13 controls the DMD 551 so as to generate the projection image based on the position of the DMD 551, with which the image having a resolution higher than a resolution of the DMD 551 can be projected.

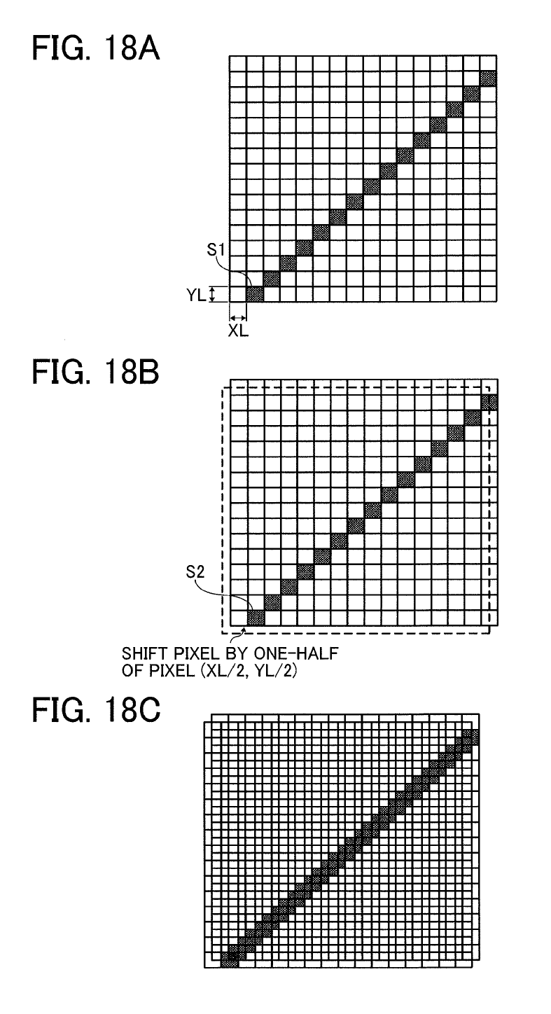

FIG. 18A, FIG. 18B, and FIG. 18C illustrate an example of a display state of an image when pixels are shifted by one-half pixel by performing the pixel-shift control operation or DMD-shift control operation.

FIG. 18A illustrates each pixel S1 in a state when the display position is not shifted (i.e., state before shifting, first position), and the size of each pixel is XL×YL. FIG. 18B illustrates each pixel S2 in a state (i.e., second position) shifted by one-half pixel (XL/2, YL/2) from the state of FIG. 18A. An operation mode that shifts pixels between two states in an oblique direction is referred to as a first operation mode.

Then, by combining the two images (FIGS. 18A and 18B), that is, alternately projecting the two images at each pixel, it is possible to achieve pseudo high resolution as illustrated in FIG. 18C. In this pixel-shift control operation, the system controller 10 generates two frames for an input video signal of one frame, in which the system controller 10 generates one frame at the first position (first frame) and another frame at the second position (second frame) for the input video signal of the one frame. Then, the movable unit controller 14 controls the movable unit 55 to shift the DMD 551 in the oblique direction, and the first frame and the second frame are projected with a state of shifting pixels for one-half pixel to achieve a higher resolution image as illustrated in FIG. 18C.

In this pixel-shift control operation, it is necessary to project the frames at twice the speed of the input video signal in order to make it look the same as the refresh rate of the input video signal. For example, if the refresh rate of the input video signal is 60 Hz (i.e. frame rate of 60 fps), it is necessary to set a drive frequency (i.e., operation frequency) for driving the movable unit 55 (i.e., DMD 551) at 120 Hz under the pixel-shift control operation to project each frame at the first position and each frame at the second position (i.e., projection of one round trip) to perform an image projection, in which high-speed image processing is required.

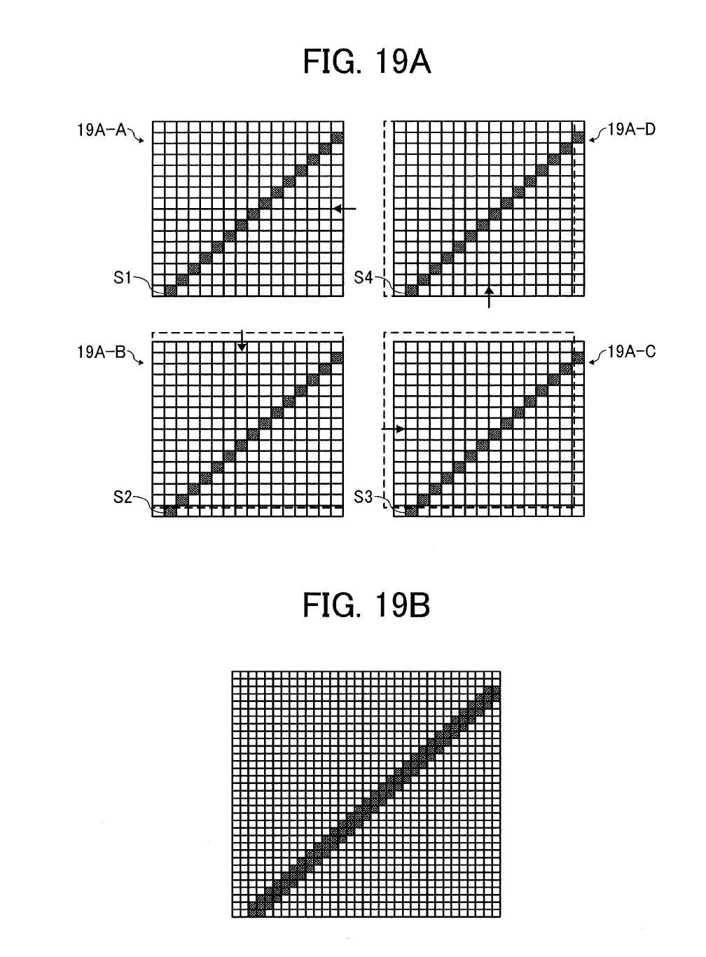

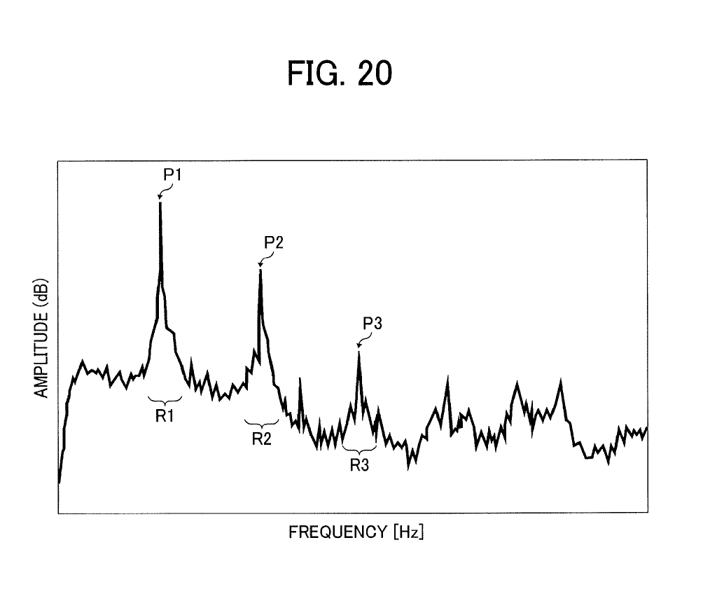

Further, the pixel-shift control operation can be performed differently. For example, it is also possible to shift the DMD 551 in the horizontal direction and the vertical direction into a total of four states under the pixel-shift control operation as illustrated in FIG. 19A and FIG. 19B. FIG. 19 A and FIG. 19B illustrate another example of a display state of an image when pixels are shifted, in which an operation mode uses four display states, which is referred to as a second operation mode.

FIG. 19A-A illustrates each pixel S1, which is in a state (i.e., state before shift, first position) when the display position is not shifted. FIG. 19A-B illustrates each pixel S2, which is in a state (i.e., second position) when the display position is shifted to the vertical direction (i.e., downward direction in FIG. 19) from the first position (FIG. 19A-A). FIG. 19A-C illustrates each pixel S3, which is in a state (i.e., third position) when the display position is shifted to the horizontal direction (i.e., right direction in FIG. 19) from the second position (FIG. 19A-B). FIG. 19A-D illustrates each pixel S4, which is in a state (i.e., fourth position) when the display position is shifted to the vertical direction (i.e., upward direction in FIG. 19) from the third position (FIG. 19A-C). Then, the position is returned to the first position from the fourth position by shifting the display position to the horizontal direction (i.e., left direction in FIG. 19).

Then, by combining the four images, that is, by projecting the image at each pixel at a high speed, a pseudo high resolution can be achieved as illustrated in FIG. 19B.

As above described, the pixels are shifted between the four positions with a manner of shifting among the four positions with a given sequential order in the second operation mode. In the second operation mode, the system controller 10 generates one frame at each of the first position to the fourth position for an input video signal of one frame, which means the system controller 10 generates four frames, and each frame is set for each of the first position to the fourth position. Then, the movable unit controller 14 controls the movable unit 55 to shift the DMD 551 in the horizontal direction and the vertical direction with a sequential order from the first position, the second position, the third position, and to the fourth position, and then an image is projected while achieving a higher resolution image.

In this pixel-shift control operation, it is necessary to project the frames at four times the speed of the input video signal in order to make it look the same as the refresh rate of the input video signal. For example, if the frame rate of the input video signal is 60 Hz (i.e. frame rate of 60 fps), it is necessary to set a drive frequency (operation frequency) for driving the movable unit 55 (i.e., DMD 551) at 240 Hz under the pixel-shift control operation to project each frame at each of the first position to the fourth position (i.e., projection of one round trip) to perform an image projection, in which high-speed image processing is required.

Further, the image projection apparatus 1 can be configured to selectively executing one of the first operation mode and the second operation mode as required, and further, the image projection apparatus 1 can be configured to execute only one of the first operation mode and the second operation mode. Further, in the embodiment, two example operation modes such as the first operation mode and the second operation mode have been described, but the shift amount and the shift direction in the pixel-shift control operation is not limited to these examples. For example, it is also possible to rotate the projected image by rotating the DMD 551.

### (Control of Cooling Fan)

FIG. 20 is an example of frequency characteristic of an operation sound of the cooling fan 20 when the cooling fan 20 is driven, in which the operation sound generated by the cooling fan 20 may become a noise sound. In this example case, the noise sound has a fundamental frequency (Hz) value obtained by multiplying the rotation speed of the cooling fan 20 per second (rotation/sec) by the number of blades of the cooling fan 20. In FIG. 20, the fundamental frequency is indicated as a peak value P1. Further, a sound pressure increases in a given range around the peak value P1 by setting the peak value P1 as the center of the given range. In this example case, a range where the sound pressure becomes higher around the fundamental frequency (i.e., peak value) is referred to as a high sound pressure range, and a high sound pressure range R1 is set for the peak value P1.

Further, as illustrated in FIG. 20, the noise sound has a peak (e.g., peak values P2, P3, . . . ) at each of given frequency components (i.e., harmonic sound components) obtained by multiplying the fundamental frequency with an integral number (e.g., two, three, and so on), and also has a high sound pressure range (e.g., high sound pressure range R2, R3, . . . ) around the peak value of each of the harmonic sound components.

For example, if the fundamental frequency of the noise sound (i.e., peak value P1) is 120 Hz, each of the harmonic sound components (i.e., peak value P2, P3 . . . ) becomes 240 Hz, 360 Hz, and so, and the high sound pressure range for the peak value P1 becomes 110 Hz to 130 Hz.

Further, the operation sound (referred to as pixel-shift noise sound) caused by the shift control under the pixel-shift control operation includes the drive frequency for driving the movable unit 55 (DMD 551) as a main component as described above.

Although the sound volume level of the pixel-shift noise sound is relatively small, when the pixel-shift control operation is switched between ON and OFF, a user may perceive the occurrence or disappearance of the operation sound caused by the pixel-shift control operation, in which the user may perceive the operation sound as a noise sound, and may feel uncomfortable.

Further, the cooling fan 20 is disposed in the image projection apparatus 1 as an indispensable cooling means that cools a heat source such as the light source 30, and when the image projection apparatus 1 is driven, the noise sound generated by the cooling fan 20 constantly occurs. Further, the noise sound generated by the cooling fan 20 has a higher sound pressure compared to the pixel-shift noise sound.

Therefore, if the pixel-shift noise sound can be masked by the noise sound generated by the cooling fan 20, a user may be less likely to perceive the pixel-shift noise sound when the pixel-shift control operation is turned ON, and it becomes possible to improve user comfortableness at the time of use of the image projection apparatus 1.

In view of the above described issue of noise sound, the image projection apparatus 1 of the embodiment is devised. The image projection apparatus (image projection apparatus 1) includes, for example, a light source (light source 30) to emit light, an image generation unit (image generation unit 50) including an image generation element (DMD 551) to generate an image using the light emitted from the light source, an optical unit (light guide unit 40, optical projection unit 60) to guide the light emitted from the light source to the image generation unit, and to enlarge and project the image generated by the image generation unit, a drive unit (movable unit 55, electromagnetic actuator to drive the movable unit 55) to change any one of a position of the image generation element and a position of at least a part (e.g., lens) of the optical unit at specific timing (e.g., FIGS. 18 and 19), and a cooling device (cooling fan 20) to cool one or more parts disposed in the image projection apparatus 1. An operation sound generated by the cooling device while the cooling device is being operated has a given frequency characteristic settable according to a drive frequency of the drive unit.

Specifically, by matching the fundamental frequency of the noise sound generated by the cooling fan 20 to the drive frequency of the pixel-shift control operation, the pixel-shift noise sound can be cancelled by the noise sound generated by the cooling fan 20 by a masking effect, and thereby a user may not perceive the noise sound caused by the pixel-shift control operation. Therefore, the user can perceive that the noise sound caused by the pixel-shift control operation is suppressed.

Further, if it is difficult to match the fundamental frequency of the noise sound generated by the cooling fan 20 to the drive frequency of the pixel-shift control operation, it is preferable to substantially match the fundamental frequency of the noise sound generated by the cooling fan 20 to the drive frequency of the pixel-shift control operation. For example, by setting the drive frequency of the pixel-shift control operation within the high sound pressure range setting the fundamental frequency of the noise sound generated by the cooling fan 20 as the center of the high sound pressure range of the cooling fan 20, a user may not perceive the pixel-shift noise sound by the masking effect as similar to a case matching the fundamental frequency of the noise sound generated by the cooling fan 20 to the drive frequency of the pixel-shift control operation.

When the fundamental frequency of the noise sound generated by the cooling fan 20 and the drive frequency of the pixel-shift control operation are matched, the masking effect becomes the highest, which is the most preferable. The closer the fundamental frequency of the noise sound generated by the cooling fan 20 and the drive frequency of the pixel-shift control operation, the higher the masking effect. Therefore, it is preferable to make a range where the masking effect becomes higher as a high sound pressure range, and to set the drive frequency of the pixel-shift control operation within this range.

When the pixel-shift control operation is performed using, for example, the operation mode of shifting between the two states as illustrated in FIG. 18, and the refresh rate of the input image is 60 Hz (i.e., frame rate is 60 fps), the drive frequency of the pixel-shift control operation becomes 120 Hz, and the pixel-shift noise sound having 120 Hz as a main component is generated. Similarly, when the pixel-shift control operation is performed using, for example, the operation mode illustrated in FIG. 19, and the refresh rate of the input image is 60 Hz (i.e., frame rate is 60 fps), the drive frequency of the pixel-shift control operation becomes 240 Hz, and the noise sound having 240 Hz as a main component is generated.

A value of the drive frequency of the pixel-shift control operation is determined in accordance with the frame rate, and when the drive frequency of the pixel-shift control operation is changed, the display of projected image is directly influenced by the changed drive frequency. Therefore, in the embodiment, the fan controller 15 changes the rotation speed of the cooling fan 20 and/or the number of blades of the cooling fan 20 set in advance such that the fundamental frequency or high sound pressure range of the noise sound generated by the cooling fan 20 is matched to the drive frequency of the pixel-shift control operation to suppress the effect of the noise sound caused by the pixel-shift control operation by using the masking effect.

For example, if the drive frequency of the pixel-shift control operation is 120 Hz and the number of blades of the cooling fan 20 is six (6), the fundamental frequency of the noise sound generated by the cooling fan 20 can be set to 120 Hz by rotating the cooling fan 20 at 20 revolutions per second (1200 rpm). Further, if it is difficult to match the fundamental frequency of the noise sound generated by the cooling fan 20 to the drive frequency of the pixel-shift control operation, the number of blades and/or the rotation speed of the cooling fan 20 can be set to values such that the drive frequency 120 Hz of the pixel-shift control operation is set within the high sound pressure range of the noise sound generated by the cooling fan 20.

Further, it may be designed to set or adjust the number of blades of the cooling fan 20 based on the rotation speed. For example, if the drive frequency of the pixel-shift control operation is 120 Hz, and the cooling fan 20 is to be rotated 15 times per second (900 rpm), the fundamental frequency of the noise sound generated by the cooling fan 20 can be set to 120 Hz by setting the number of blades of the cooling fan 20 to eight (8).

Further, the rotation speed of the cooling fan 20 and the number of blades of the cooling fan 20 can be set with any values such that the cooling fan 20 can be used as the cooling device of the image projection apparatus 1. For example, if the rotation speed of the cooling fan 20 is set too high, the noise sound generated by the cooling fan 20 may become too great and may exceed an allowable level defined by a noise sound standard while if the rotation speed of the cooling fan 20 is set too low, the size of the cooling fan 20 is required to be greater to achieve the effective cooling effect. Therefore, it is preferable to determine the rotation speed and the number of blades of the cooling fan 20 in view of these issues.

Further, as described above, the noise sound generated by the cooling fan 20 also has a peak in the harmonic sound components of the fundamental frequency. Therefore, if it is difficult to match the fundamental frequency of the noise sound generated by the cooling fan 20 to the drive frequency of the pixel-shift control operation, a frequency that is obtained by multiplying the fundamental frequency of the noise sound generated by the cooling fan 20 with an integral number (e.g., two, three, and so on) and the drive frequency of the pixel-shift control operation are matched or approximated with each other.

For example, if the drive frequency of the pixel-shift control operation is 120 Hz and the number of blades of the cooling fan 20 is six (6), and the cooling fan 20 is rotated at 10 revolutions per second (600 rpm), the fundamental frequency of the noise sound generated by the cooling fan 20 becomes 60 Hz. Therefore, a frequency component corresponding to two times of the fundamental frequency of the noise sound generated by the cooling fan 20 can be matched to the drive frequency of the pixel-shift control operation, with which the pixel-shift noise sound can be suppressed by the masking effect.

As described above, the image projection apparatus 1 according to the embodiment can perform the pixel-shift control operation for achieving the higher resolution of projection image without disposing a silencer that masks the noise sound caused by the pixel-shift control operation, and the above described configuration of the image projection apparatus 1 can suppress the occurrence of the noise sound in the image projection apparatus 1, with which a user may not perceive the operation sound of the pixel-shift control operation.

Further, in the above-described embodiment, the pixel-shift control operation is performed by shifting the image generation element (e.g., DMD 551), but not limited thereto. For example, the pixel-shift control operation can be performed by moving an optical element (e.g., one lens configuring the optical projection unit), in which a drive frequency of a drive unit that shifts the optical element can be set similarly as the drive frequency of the drive unit that controls the shifting of the image generation element (e.g., DMD 551). Therefore, by substantially matching the fundamental frequency of the noise sound generated by the cooling fan 20 or the harmonic sound component of the noise sound generated by the cooling fan 20 to the drive frequency of the drive unit that shifts the optical element, the pixel-shift noise sound caused by the shift control of the optical element can be suppressed.

In the above-described embodiment, the frequency characteristic of the noise sound of the cooling fan 20 is calculated from factors of the rotation speed of the cooling fan 20 and the number of blades of the cooling fan 20. Further, the frequency characteristics of the noise sound generated by the cooling fan 20 (such as a range width of the high sound pressure range) may vary depending on other factors such as a total size of the cooling fan 20, a size of the blades of the cooling fan 20, and a shape of the blades of the cooling fan 20. Therefore, it is preferable to match the frequency characteristics of the noise sound generated by the cooling fan 20 to the drive frequency of the pixel-shift control operation in view of these factors. Specifically, the frequency characteristics of the operation sound generated by the cooling fan 20 can be measured when the cooling fan 20 of the image projection apparatus 1 is being operated, and then the rotation speed of the cooling fan 20 can be controlled based on the measured frequency characteristics of the operation sound generated by the cooling fan 20 such that the pixel-shift noise sound can be masked by the operation sound generated by the cooling fan 20.

Further, the above embodiment is applied to the cooling fan 20 set with a given rotation speed and a given number of blades and provided for the light source unit 4, but the above embodiment can be also applied to control other fans provided in the image projection apparatus 1.

Further, in the above-described embodiment, the image projection apparatus 1 using a digital light processing (DLP) is described as an example of image projection apparatuses, but not limited to thereto. The above embodiment can be applied to any configuration that can perform the pixel-shift control operation.

Further, in the above embodiment, a horizontally placed projector is used as an example of the image projection apparatus, but the above embodiment can be also applied to a vertically placed ultra-short focus type projector using an optical reflection.

Further, in the above embodiment, the electromagnetic actuator (i.e., electromagnetic drive unit) is used as the drive unit of the image generation element, but not limited thereto. For example, other drive unit can be employed for the image generation element.

As to the above described image projection apparatus, the image projection apparatus can suppress the occurrence of noise sound caused in the image projection apparatus even if the pixel-shift control operation is performed.

Numerous additional modifications and variations for the modules, the units, and the image projection apparatuses are possible in light of the above teachings. It is therefore to be understood that within the scope of the appended claims, the description of present disclosure may be practiced otherwise than as specifically described herein. For example, elements and/or features of different examples and illustrative embodiments may be combined each other and/or substituted for each other within the scope of present disclosure and appended claims.

What is claimed is:

1. An image projection apparatus comprising:
a light source to emit light;
an image generation unit including an image generation element to generate an image using the light emitted from the light source;
an optical unit to guide the light emitted from the light source to the image generation unit, and to enlarge and project the image generated by the image generation unit;
a drive unit to change any one of a position of the image generation element and a position of at least a part of the optical unit at specific timing; and
a cooling device to cool one or more parts disposed in the image projection apparatus, an operation sound generated by the cooling device while the cooling device is being operated has a given frequency characteristic settable according to a drive frequency of the drive unit.

2. The image projection apparatus of claim 1, wherein the image generation unit further includes a movable unit to include the image generation element in the movable unit,
wherein the drive unit changes a position of the movable unit including the image generation element within a specific moveable range set for the movable unit at specific timing.

3. The image projection apparatus of claim 1, wherein the drive frequency of the drive unit is set within a first frequency range setting a fundamental frequency of the operation sound generated by the cooling device as a center of the first frequency range.

4. The image projection apparatus of claim 1, wherein the drive frequency of the drive unit is set within a second frequency range setting a harmonic sound component of a fundamental frequency of the operation sound generated by the cooling device as a center of the second frequency range.

5. The image projection apparatus of claim 1, further comprising a controller to control a rotation speed of the cooling device according to the drive frequency of the drive unit.

6. The image projection apparatus of claim 1, wherein the cooling device has one or more blades, and the number of the blade of the cooling device is adjustable according to the drive frequency of the drive unit.

7. The image projection apparatus of claim 1, wherein the cooling device that cools the light source is a cooling fan.

8. A method of controlling an image projection apparatus including a light source to emit light, an image generation unit including an image generation element to generate an image using the light emitted from the light source, an optical unit to guide the light emitted from the light source to the image generation unit, and to enlarge and project the image generated by the image generation unit, a drive unit to change any one of a position of the image generation element and a position of a part of the optical unit at specific timing, and a cooling device to cool one or more parts disposed in the image projection apparatus, the method comprising:
operating the cooling device to cool the one or more parts disposed in the image projection apparatus; and
controlling an operation of the cooling device to set frequency characteristic of an operation sound generated by the cooling device according to a drive frequency of the drive unit.
